(19) United States
(12) Patent Application Publication
(10) Pub. No.: US 2006/0277402 A1
(43) Pub. Date: Dec. 7, 2006

(54) System startup method

(75) Inventor: Noboru Wakabayashi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/371,255

(22) Filed: Mar. 7, 2006

(30) Foreign Application Priority Data
May 18, 2005 (JP) 2005-144847

(51) Int. Cl. G06F 15/177

(52) U.S. Cl. 713/1

(57) ABSTRACT

An object of the present invention is to provide a system startup method for automatically starting a function that is suitable for users at the time of system startup with the startup time of a system being shortened. A startup list is provided which describes which one or ones of program components in the system to be started at the time of system startup. When the system is started up, the program components are started according to the startup list. During the operation of the system, by adding/deleting a program component to/from the startup list on the basis of the executed time and execution count of the program component and the like, a startup-list management component for managing the startup list updates the startup list so that the startup list suits users.

### CLAIM OF PRIORITY

The present application claims priority from Japanese patent application No. JP2005-144847 filed on May 18, 2005, the content of which is hereby incorporated by reference into this application.

### BACKGROUND OF THE INVENTION

The present invention relates to a technology for starting up a software system in information processing equipment. More specifically, the invention relates to a system startup technology for automatically determining a plurality of program components to be started.

In the field of not only conventional personal computers but also home electric appliances, data processing capability increases year by year, and therefore systems become sophisticated and complicated. As a result, a length of time required to start up each system is also increasing. One bloated function in a system may cause the increase in the system startup time. However, an increase in the number of functions in the system may also lengthen the system startup time. There is also a case where even a function that is not used by users at all is added to the system. Therefore, at the time of system startup, the users are problematically forced to wait until such an unnecessary function is started.

With the objective of dealing with this problem, there is provided a method in which only required minimum functions are first included in a system at the time of system construction, and only a function required by users is added to the system thereafter.

In addition, patent document 1 (Japanese Patent Laid-open No. 11-003129) describes the technology in which how to use a system is set by a user, and then only functions relating to the use are started at the time of starting the system.

### SUMMARY OF THE INVENTION

Patent document 1 will be described with reference to FIG. 13 below. When a user starts up a system, the user sets the use of the system by use of a startup use and function setting section 1301. Then, by use of a use-based function specification program execution section 1302, functions are selected on the basis of the use. After that, the functions which are specified on the basis of the use are executed by use of a start program execution section 1303. As a result, the user can set functions required at the time of system startup only by setting the use without being conscious of specifications at a function level, and thereby it is possible to shorten the processing time taken by functions that are not used.

However, the conventional method described in patent document 1 necessitates the user to directly specify a function, or its use, required at the time of starting up the system. The user, therefore, is required to have full knowledge of kinds of functions included in the system, or to have full knowledge of the use of the functions.

An object of the present invention is to provide a system startup method for automatically starting a function that is suitable for users at the time of system startup.

Here, a program having one specific function is called a program component. To be more specific, the program component is a program that is implemented on a function basis. The program component is independent of the other program components. The program component is something like an application used in a personal computer. However, not only an application but also a driver or middleware may also be treated as a program component here.

In order to achieve the above-mentioned objects, according to one aspect of the present invention, there is provided a system startup method of a system having a startup list which describes program components to be started at the time of system startup; and a management program component for managing each program component. This system startup method comprises the steps of: storing a time stamp when a program component is executed; periodically comparing the time stamp with the current time, and thereby deleting the program component from the startup list, or adding the program component to the startup list, so as to manage the startup list; and starting the program components described in the startup list when the system is started up.

If a certain program component is not executed for a long time, the program component can be judged to be a program component that is not necessary for a user. Therefore, the program component is deleted from the startup list. On the other hand, if a program component that is not included in the startup list is frequently started according to a user's instruction after system startup, the program component can be judged to be a program component that is necessary for the user. Therefore, the program component is added to the startup list.

As a result of the increased number of times the user uses the system without any special instruction to the system, only functions that are suitable for the user are automatically started. This makes it possible to shorten the time taken to start functions that are not used by the user. Furthermore, since unnecessary functions are not started, the amount of memory to be used in the whole system can be saved.

According to the present invention, a function that is suitable for the user can be automatically started at the time of system startup while shortening the startup time of the system.

### BRIEF DESCRIPTION OF THE DRAWINGS

FIG. 1 is a diagram schematically illustrating a system startup method according to one embodiment of the present invention;

FIG. 2 is a diagram illustrating a startup list according to a first embodiment of the present invention;

FIG. 3 is a block diagram illustrating a startup-list management component according to the first embodiment of the present invention;

FIG. 4 is a block diagram illustrating a program component according to the first embodiment of the present invention;

FIG. 5 is a flowchart illustrating processing steps performed at the time of system startup according to the first embodiment of the present invention;

FIG. 6 is a flowchart illustrating processing steps performed when a program component is executed according to the first embodiment of the present invention;

FIG. 7 is a flowchart illustrating processing steps for managing a startup list according to the first embodiment of the present invention;

FIG. 8 is a diagram illustrating a startup list according to a second embodiment of the present invention;

FIG. 9 is a block diagram illustrating a startup-list management component according to the second embodiment of the present invention;

FIG. 10 is a block diagram illustrating a program component according to the second embodiment of the present invention;

FIG. 11 is a flowchart illustrating processing steps performed when a program component is executed according to the second embodiment of the present invention;

FIG. 12 is a flowchart illustrating processing steps for managing a startup list according to the second embodiment of the present invention; and

FIG. 13 is a diagram illustrating the prior art.

### DESCRIPTION OF THE PREFERRED EMBODIMENTS

Embodiments of the present invention will be described with reference to drawings below.

### First Embodiment

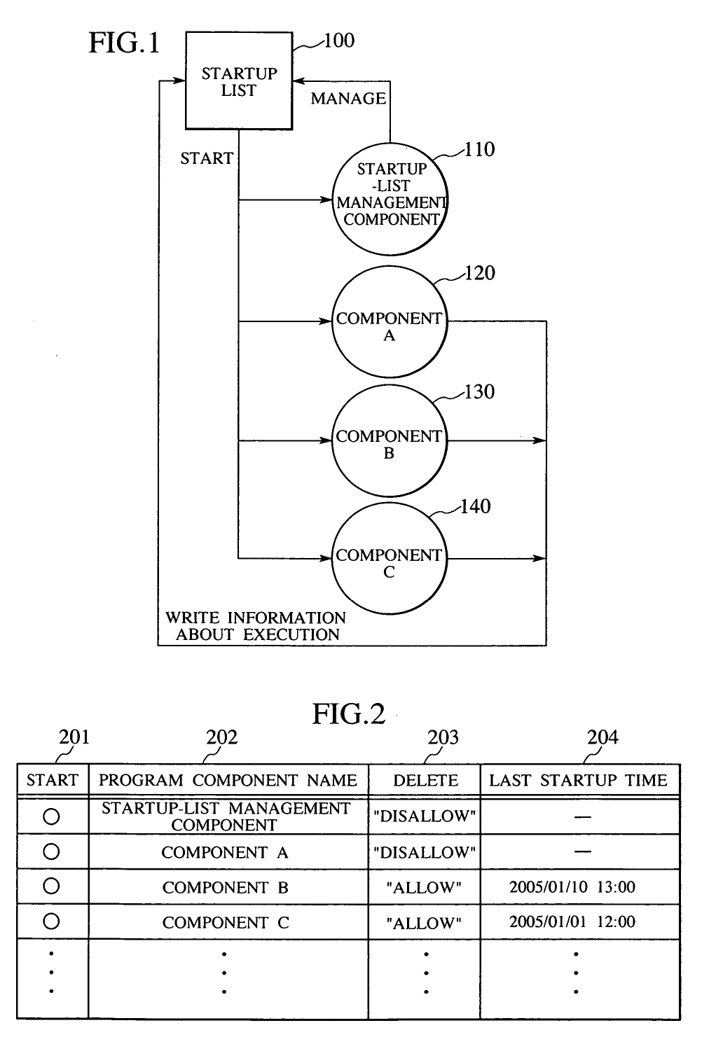

A first embodiment relates to a system startup method according to the present invention. This embodiment will be described with reference to FIGS. 1 through 7 below.

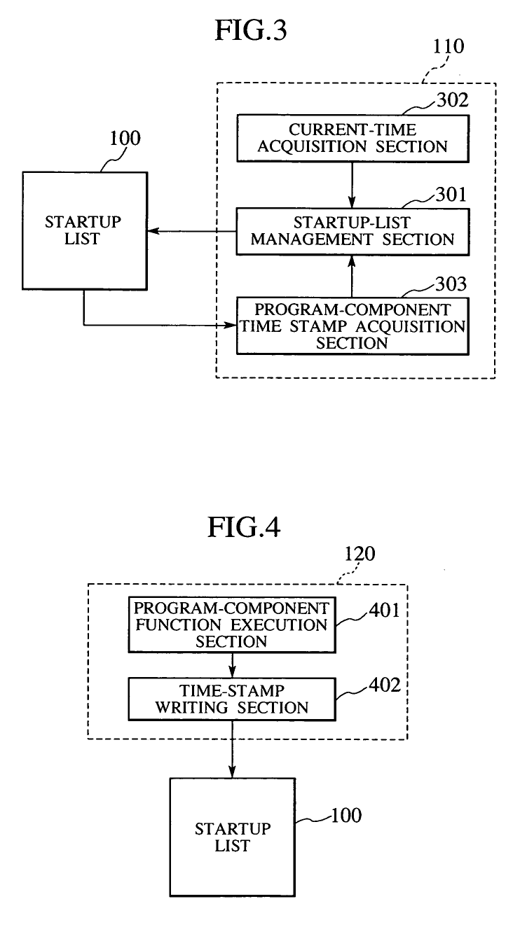

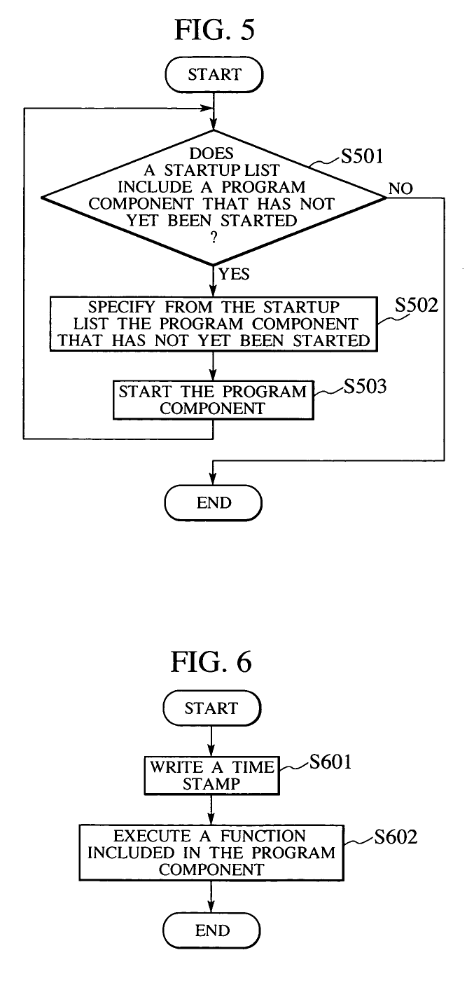

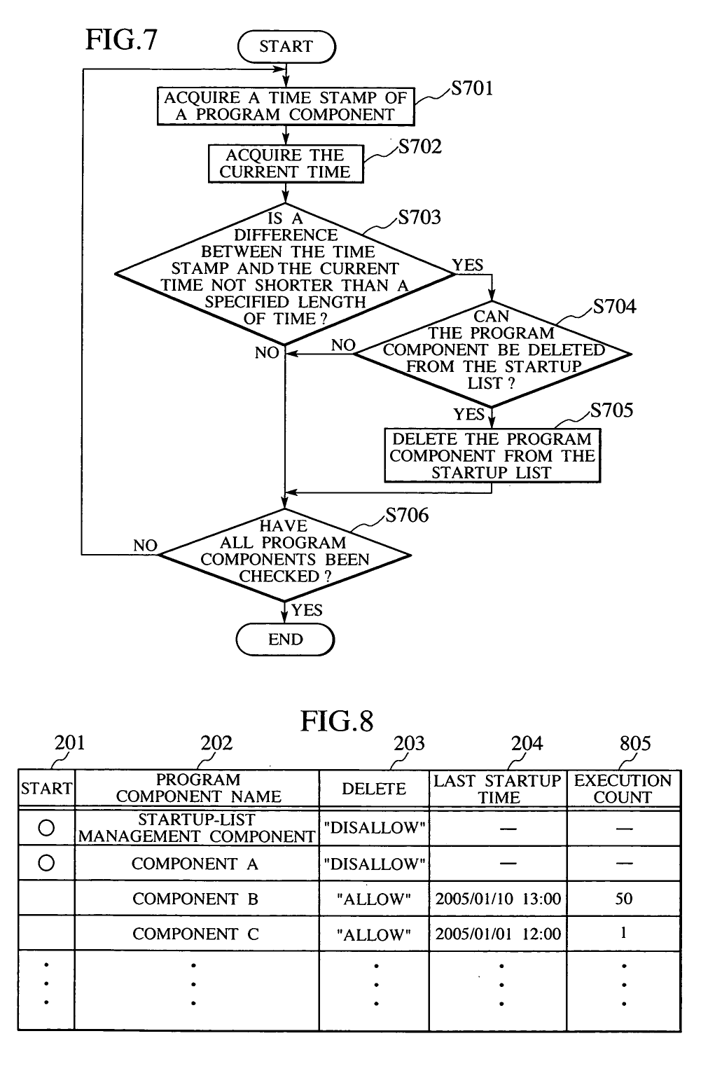

FIG. 1 is a diagram schematically illustrating a system startup method according to the present invention. FIG. 2 is a diagram illustrating a list of program components to be started at the time of system startup, and a startup list which describes information about each of the program components. FIG. 3 is a block diagram illustrating sections included in a startup-list management component shown in FIG. 1, and communications with the startup list. FIG. 4 is a block diagram illustrating sections included in a program component, and communications with the startup list. FIG. 5 is a flowchart illustrating processing steps performed at the time of system startup. FIG. 6 is a flowchart illustrating processing steps performed at the time of executing a program component. FIG. 7 is a flowchart illustrating processing steps in which the startup-list management component periodically manages the startup list.

FIG. 1 is a diagram schematically illustrating a system startup method according to the present invention. Reference numeral 100 denotes a list of program components to be started at the time of system startup, and a startup list which describes information about each of the program components. Reference numeral 110 denotes a startup-list management component which is a program component for managing the startup list 100. Reference numerals 120, 130 and 140 denote components A, B and C, respectively, each of which is a program component for achieving a specific function. Incidentally, although FIG. 1 shows only three program components other than the startup-list management component 110, the number of program components is unlimited. Program components that should be started at the time of system startup are only program components that are described in the startup list 100 as program components to be started. The startup list 100 is initially so configured that all program components in the system are started. Accordingly, all the program components are started at the time of installing the system.

During the operation of the system, if a program component is executed according to a user's instruction, the program component writes to the startup list 100 a time stamp of the time at which the execution has been started. The startup-list management component 110 refers to the startup list 100 at each constant period in order to compare the executed time of each program component described in the startup list 100 with the current time. As a result of the comparison, if a specified period of time has passed, the user can judge that the program component is not necessary. Accordingly, the startup-list management component 110 deletes the unnecessary program component from the startup list 100. As a result, the program component that has not been executed for the specified period of time is not started at the next system startup. Therefore, the startup time is shortened.

FIG. 2 is a diagram illustrating one example of the startup list 100 shown in FIG. 1. Reference numeral 201 denotes a start check field in which a checkmark indicating whether or not to start the program component at the time of system startup is placed. Reference numeral 202 denotes a program component name field in which, for example, each program component name or ID is stored. A program component is identified by the program component name or ID thereof. Reference numeral 203 denotes a deletion allow/disallow field indicating whether or not the program component can be deleted from the startup list, more specifically, indicating whether or not a checkmark in the start check field 201 can be removed. Reference numeral 204 denotes a last startup time field which stores a time stamp indicating the time at which the program component has been started/executed. Incidentally, a program component whose deletion allow/disallow field 203 is “disallow” is indispensable to the system startup.

FIG. 3 is a block diagram illustrating sections included in the startup-list management component 110, and communications with the startup list 100. Reference numeral 301 denotes a startup-list management section for managing the startup list 100. Reference numeral 302 denotes a current-time acquisition section for acquiring the current time. Reference numeral 303 denotes a program-component time stamp acquisition section for acquiring a time stamp described in the last startup time field 204 corresponding to a program component specified from the startup list 100. The startup-list management component 110 includes the startup-list management section 301, the current-time acquisition section 302, and the program-component time stamp acquisition section 303. During the operation of the system, the startup-list management component 110 periodically acquires from the startup list 100 the last executed time of the program component by use of the program-component time stamp acquisition section 303. After that, the startup-list management component 110 acquires the current time by use of the current-time acquisition section 302, and then compares the current time with the last executed time. If it is judged that a specified period of time has passed, the startup-list management component 110 removes a checkmark from the start check field 201 of the program component in the startup list 100 by use of the startup-list management section 301.

FIG. 4 is a block diagram illustrating sections included in the program component A 120 shown in FIG. 1, and communications with the startup list 100. Incidentally, the other program components B 130 and C 140 are also treated in the same manner. Reference numeral 401 denotes a program-component function execution section for executing a function provided by a program component. Reference numeral 402 denotes a time-stamp writing section which acquires the time at which the execution of the program-component function execution section 401 has been started, and which writes the time to the last startup time field 204 corresponding to the program component in the startup list 100.

Next, operation in this embodiment will be described in detail with reference to FIGS. 5, 6 and 7.

FIG. 5 is a flowchart illustrating processing steps performed at the time of system startup. Each checkmark is placed in the start check field 201 of the startup list 100 to instruct that a corresponding program component should be started at the time of system startup. When a system is started up, however, a judgment is made as to whether or not the corresponding program component has already been started (step S501). If it is judged that there is a program component that has not yet been started, the program component is specified from the startup list 100 (step S502). Then, the program component in question is started (step S503). After step S503 is executed, the process returns to step S501. Then, all the program components are started that are instructed to start at the time of system startup by placing checkmarks and that have not yet been started. If it is judged in step S501 that all of the program components have already been started, system startup processing ends. Incidentally, the starting order for the program components may be as described in the startup list 100 or arbitrary.

FIG. 6 is a flowchart illustrating processing steps performed at the time of executing a program component. During the operation of the system, if the execution of a program component is instructed by a user, or the like, the program component acquires the current time using the time-stamp writing section 402, and then writes the current time to the last startup time field 204 corresponding to the program component in question in the startup list 100 (step S601). After that, the program component executes its own function by use of the program-component function execution section 401 (step S602). When the execution of the own function is completed, the processing ends. Incidentally, processing in step S601 is not performed for a program component required for the system (more specifically, a program component, the deletion allow/disallow field 203 of which is “disallow” in the startup list 100). Accordingly, for the program component required for the system, only its own function is executed. This makes it possible to exclude unnecessary processing when a program component is executed that cannot be deleted from the system startup list.

FIG. 7 is a flowchart illustrating processing steps in which the startup-list management component 110 periodically manages the startup list 100. During the operation of the system, by use of the program-component time stamp acquisition section 303, the startup-list management component 110 periodically acquires a time stamp provided when a program component has been started last time, said time stamp being described in the last startup time field 204 of the startup list 100 (step S701). After that, the startup-list management component 110 acquires the current time (step S702), and then compares the last startup time of the program component acquired in step S701 with the current time to judge whether or not a specified period of time has passed (step S703). If it is judged that the specified period of time has passed, the deletion allow/disallow field 203 corresponding to the program component in the startup list 100 is referred to, and thereby a judgment is made as to whether or not the program component in question can be deleted from the startup list 100. To be more specific, a judgment is made as to whether or not a checkmark can be removed from the start check field 201 corresponding to the program component in question in the startup list 100 (step S704).

If it is judged that the program component can be deleted from the startup list 100, the program component is deleted from the startup list 100. To be more specific, a checkmark is removed from the start check field 201 corresponding to the program component in the startup list 100 (step S705). If it is judged in step S703 that the specified period of time has not passed, or in step S704 that the program component cannot be deleted from the startup list 100, or after step S705, a judgment is made as to whether or not processing from step S701 to step S705 has already been completed for all program components described in the startup list 100 (step S706). If it is judged that the processing has already been completed for all of the program components, the series of processing ends. If it is not judged that the processing has already been completed for all of the program components, the process returns to step S701, and then the processing is performed for a program component that has not been handled yet.

Incidentally, the startup list 100 in this embodiment describes all program components included in the system. However, a program component that is indispensable for starting up the system may also be excluded from the startup list 100. In such a case, in the processing at the time of system startup shown in FIG. 5, it is necessary to start, before step S501, the program component that is indispensable to the system startup. However, the deletion allow/disallow field 203 of the startup list 100 shown in FIG. 2 becomes unnecessary. In addition, it is also possible exclude the judgment processing in step S704 shown in FIG. 7.

Moreover, in this embodiment, a program component that is not frequently used by users is deleted from the startup list 100, and consequently the program component is not started at the time of system startup. However, instead of deleting the program component in question from the startup list 100, the starting order of the program component in question may also be delayed at the time of system startup. This enables the users to quickly start a program component that is frequently used.

According to this embodiment, all program components are started in the beginning. However, while users continue to use the system, the manner in which program components are started is automatically changed as follows: only program components which are frequently used by the uses (that is to say, only functions that are frequently used) are started at the time of system startup. This makes it possible to shorten the startup time at the time of system startup. Further, it is possible to save the amount of memory by the memory size used by the program components that are not started.

### Second Embodiment

In contrast to the first embodiment, according to a second embodiment, only required program components are started at the time of system startup, and then a program component that is frequently used by users is added to a startup list during system operation. Incidentally, a rough outline of a system startup method in this embodiment is the same as that shown in FIG. 1; and processing steps performed at the time of system startup in this embodiment are the same as those shown in the flowchart in FIG. 5.

The second embodiment according to the present invention will be described with reference to FIGS. 8 through 12 below.

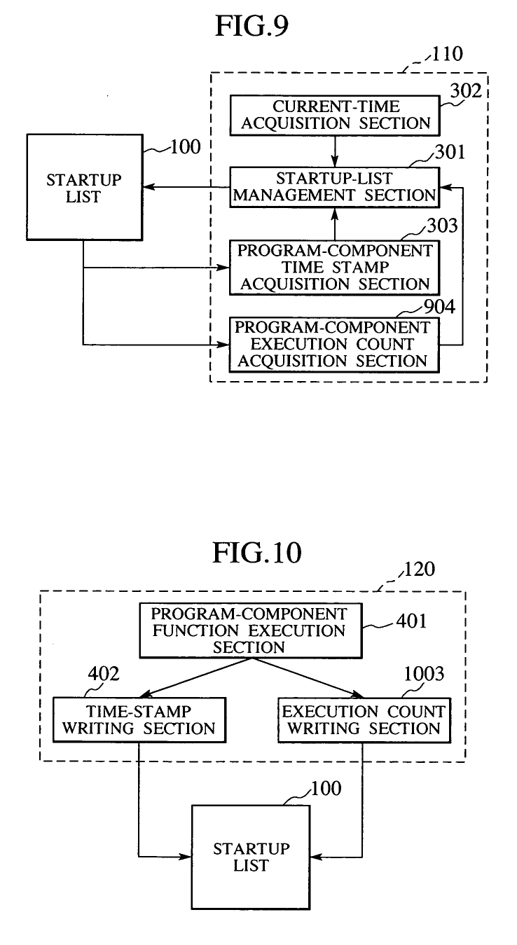

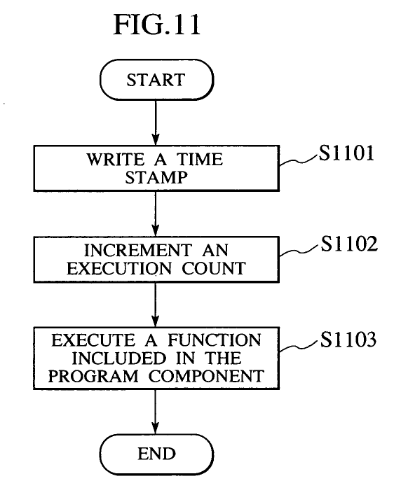

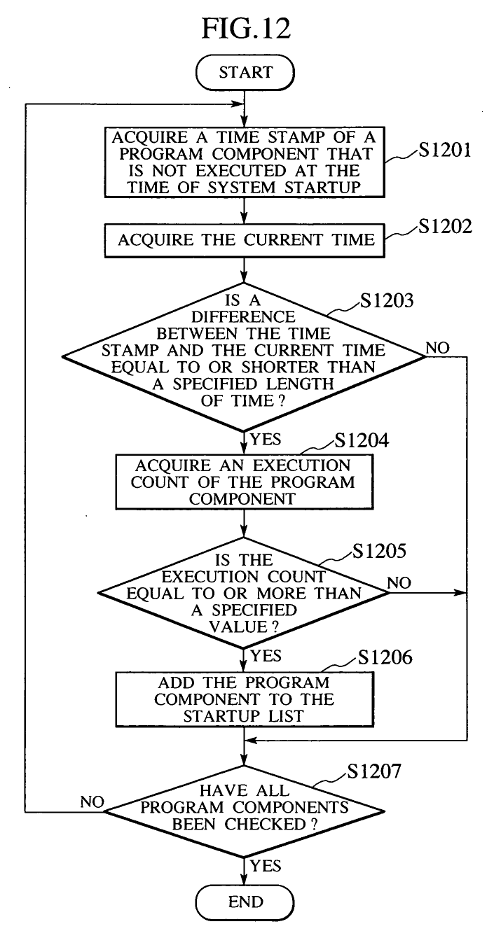

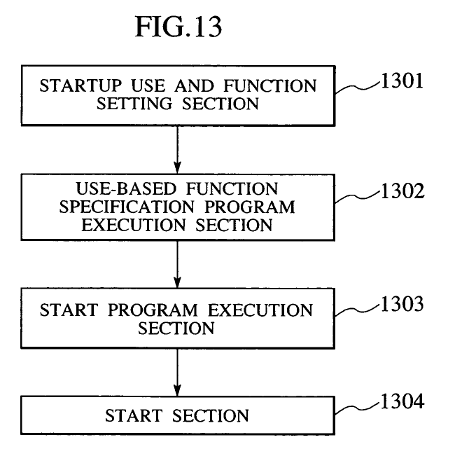

FIG. 8 is a diagram illustrating a list of program components to be started at the time of system startup, and a startup list which describes information about each of the program components. FIG. 9 is a block diagram illustrating sections included in the startup-list management component 110, and communications with the startup list. FIG. 10 is a block diagram illustrating sections included in a program component, and communications with the startup list. FIG. 11 is a flowchart illustrating processing steps performed at the time of executing a program component. FIG. 12 is a flowchart illustrating processing steps in which the startup-list management component periodically manages the startup list.

FIG. 8 is a diagram illustrating one example of the startup list 100 according to this embodiment. In this embodiment, an execution count field 805 is added to the startup list in FIG. 2 described in the first embodiment. The execution count field 805 stores the number of times a program component has been executed.

FIG. 9 is a block diagram illustrating sections included in the startup-list management component 110 according to this embodiment, and communications with the startup list. In this embodiment, a program-component execution count acquisition section 904 is added to the block diagram in FIG. 3 described in the first embodiment. The program-component execution count acquisition section 904 acquires the execution count described in the execution count field 805 corresponding to a program component specified from the startup list 100. The execution count of the program component acquired by the program-component execution count acquisition section 904 is sent to the startup-list management section 301 where the execution count is used to manage the startup list 100.

FIG. 10 is a block diagram illustrating sections included in a program component according to this embodiment, and communications with the startup list 100. In this embodiment, an execution count writing section 1003 is added to the block diagram in FIG. 4 described in the first embodiment. The execution count writing section 1003 increments a value of the execution count field 805 corresponding to the program component in the startup list 100 when the execution of the program-component function execution section 401 is started.

FIG. 11 is a flowchart illustrating processing steps performed at the time of executing a program component according to this embodiment. During the operation of the system, if the execution of a program component is instructed by a user, or the like, the program component acquires the current time by use of the time-stamp writing section 402, and then writes the current time to the last startup time field 204 corresponding to the program component in question in the startup list 100 (step S1101). Next, by use of the execution count writing section 1003, the program component increments a value stored in the execution count field 805 corresponding to the program component in question in the startup list 100 (step S1102). After that, the program component executes its own function by use of the program-component function execution section 401 (step S1103). When the execution of the own function is completed, the processing ends. Incidentally, processing in steps S1101 and S1102 is not performed for a program component required for the system (more specifically, a program component, the deletion allow/disallow field 203 of which is “disallow” in the startup list 100). Accordingly, for the program component required for the system, only its own function is executed. This makes it possible to exclude unnecessary processing when a program component is executed that cannot be deleted from the system startup list.

FIG. 12 is a flowchart illustrating processing steps in which the startup-list management component 110 periodically manages the startup list 100 according to this embodiment. During the operation of the system, the startup-list management component 110 performs processing shown in FIG. 12 at each constant period. For a program component that is not started at the time of system startup (more specifically, a program component for which a checkmark is not placed in the start check field 201 of the startup list 100 shown in FIG. 8), the startup-list management component 110 acquires a time stamp at the last start of the program component, which is described in the last startup time field 204 of the startup list 100, by use of the program-component time stamp acquisition section 303 (step S1201). After that, the startup-list management component 110 acquires the current time (step S1202), and then compares the last startup time of the program component acquired in step S1201 with the current time to judge whether or not a specified period of time has passed (step S1203). If it is judged that the specified period of time has not passed yet, the startup-list management component 110 acquires an execution count of the program component, which is described in the execution count field 805 of the startup list 100, by use of the program-component execution count acquisition section 904 (step S1204). A judgment is made as to whether or not the execution count of the program component, which has been acquired in step S1204, is a specified value or more (step S1205). If the execution count is the specified value or more, it is judged that the program component in question is frequently executed by users. Accordingly, the program component is added to the startup list 100.

To be more specific, a checkmark is placed in the start check field 201 corresponding to the program component in the startup list 100 (step S1206). If it is judged in step S1203 that the specified period of time has passed, or if it is judged in step S1205 that the execution count is the specified value or less, or after step S1206 is executed, a judgment is made as to whether or not steps from S1201 to S1206 have already been executed for all program components described in the startup list 100 (step S1207). If it is judged that the processing has already been completed for all of the program components, the series of processing ends. If it is not judged that the processing has already been completed for all of the program components, the process returns to step S1201, and then the processing is performed for a program component that has not been handled yet.

Incidentally, the startup list 100 in this embodiment describes all program components included in the system. However, as is the case with the first embodiment, a program component that is indispensable for starting up the system may also be excluded from the startup list 100. This makes it possible to reduce the memory size required for the startup list 100, and to eliminate the need for processing required for managing the startup list 100. In addition, the adding section for adding a program component to the startup list 100 in this embodiment makes a judgment through the last executed time and execution count of the program component. However, the execution time length may also be used for the judgment. As a result, a program component that has been continuously used for a long time although its execution count is small can be added to the startup list. Therefore, convenience for users is improved.

According to this embodiment, only program components required for starting up the system are started in the beginning. However, while users continue to use the system, the manner in which program components are started is automatically changed as follows: program components which are frequently used by the uses (that is to say, functions that are frequently used) are started at the time of system startup. This makes it possible to shorten the time taken before the users use functions.

### Third Embodiment

A third embodiment is a combination of the first embodiment and the second embodiment. Incidentally, a rough outline of a system startup method in this embodiment is the same as that shown in FIG. 1. Processing steps performed at the time of system startup in this embodiment are the same as those shown in the flowchart in FIG. 5. A startup list in this embodiment is the same as that shown in FIG. 8. A block diagram illustrating sections included in the startup-list management component 110 according to this embodiment, and illustrating communications with the startup list, is the same as the block diagram shown in FIG. 9. A block diagram illustrating sections included in a program component according to this embodiment, and illustrating communications with the startup list, is the same as that shown in FIG. 10. A flowchart illustrating processing steps performed at the time of executing a program component according to this embodiment is the same as that shown in FIG. 11. Processing steps in which the startup-list management component periodically adds a program component to the startup list is the same as those shown in the flowchart in FIG. 12. Processing steps in which the startup-list management component periodically deletes a program component from the startup list is the same as those shown in the flowchart in FIG. 7.

As is the case with the second embodiment, the startup list describes only program components required for system startup in the beginning. In other words, only program components required at the time of system startup are started in the beginning. If a program component is executed according to a user's instruction or the like, the processing shown in FIG. 11 is performed, and then information about the execution of the program component is described in the startup list. During the operation of the system, the startup-list management component periodically performs processing shown in FIG. 12, and thereby a program component that is frequently used by users is added to the startup list. However, if a program component that is frequently used up to the present is not used because for example preferences of users have been changed, it is useless to start the program component at the time of system startup. Therefore, during the operation of the system, the startup-list management component periodically performs the processing shown in FIG. 7 to delete the program component that is not frequently used. By repeating addition/deletion to/from this startup list, a program component that is suitable for users can always be started at the time of system startup.

Incidentally, as shown in FIG. 7, a judgment as to whether or not to delete a program component from the startup list is made with reference to only the last executed time of the program component. However, the judgment may also be made by an execution count of the program component. To be more specific, after step S703 in FIG. 7, a judgment is made as to whether or not the execution count is smaller than a specified value. If the execution count is smaller than the specified value, processing in step S704 is performed. On the other hand, if the execution count is the specified value or more, processing in step S706 is performed. It is to be noted that this specified value is the number obtained by adding a specified value to the number of times the system has been started up. As a result, program components are more reliably deleted from the startup list, and convenience of users is improved.

According to this embodiment, even if preferences of users change, it is possible to provide a startup list that is suitable for users. In other words, it is possible to always start up the system within the startup time that is suitable for users.

What is claimed is:

1. A system startup method for starting up a system having a plurality of program components and a startup list which describes program components to be started at the time of system startup, said system startup method comprising the steps of:
storing the executed time when a program component is executed;
comparing the executed time with the current time and deleting the program component from the startup list if it is judged that a specified period of time has passed from the executed time;
periodically executing said deletion step; and
starting the program components described in the startup list when the system is started up.

2. The system startup method according to claim 1, wherein:
said startup list initially describes all program components included in the system.

3. The system startup method according to claim 1, wherein:
program components required for system startup are excluded from the startup list.

4. The system startup method according to claim 1, wherein:
said deletion step additionally includes a step of deleting the program component from the startup list, if the number of times the program component has been executed is a specified value or less.

5. A system startup method for starting up a system having a plurality of program components and a startup list which describes program components to be started at the time of system startup, said system startup method comprising the steps of:
storing the executed time and an execution count when a program component is executed;
adding the program component to the startup list, if a difference between the executed time and the current time falls within a specified length of time and the execution count is a specified value or more;
periodically executing said addition step; and
starting the program components described in the startup list when the system is started up.

6. The system startup method according to claim 5, wherein:
said startup list initially describes only program components required for system startup.

7. The system startup method according to claim 5, wherein:
program components required for system startup are excluded from the startup list.

8. The system startup method according to claim 5, wherein:
said addition step additionally includes a step of adding the program component to the startup list, if the execution time length of the program component is longer than or equal to a specified length of time.

9. A system startup method for starting up a system having a plurality of program components and a startup list which describes program components to be started at the time of system startup, said system startup method comprising the steps of:
storing the executed time and an execution count when a program component is executed;
adding the program component to the startup list, if a difference between the executed time and the current time falls within a specified length of time and the execution count is a specified value or more;
comparing the executed time with the current time, and deleting the program component from the startup list if it is judged that a specified period of time has passed from the executed time;
periodically executing said addition step and said deletion step; and
starting the program components described in the startup list when the system is started up.

10. The system startup method according to claim 9, wherein:
said startup list initially describes only program components required for system startup.

11. The system startup method according to claim 9, wherein:
program components required for system startup are excluded from the startup list.

12. The system startup method according to claim 9, wherein:
said addition step additionally includes a step of adding the program component to the startup list, if the execution time length of the program component is longer than or equal to a specified length of time.

13. The system startup method according to claim 9, wherein:
said deletion step additionally includes a step of deleting the program component from the startup list, if the number of times the program component has been executed is a specified value or less.
